(19) United States
(12) Patent Application Publication
(10) Pub. No.: US 2008/0112256 A1
(43) Pub. Date: May 15, 2008

(54) Silo mixer with adjustable A-frame height support

(76) Inventor: Stephen C. Vandewinckel, Livonia, NY (US)

Correspondence Address: JACOBSON HOLMAN PLLC, 400 SEVENTH STREET N.W., SUITE 600, WASHINGTON, DC, 20004, US

(21) Appl. No.: 11/599,588

(22) Filed: Nov. 15, 2006

(51) Int. Cl. B28C 5/18

(52) U.S. Cl. 366/6; 366/62

(57) ABSTRACT

An adjustably supported mortar mixer includes a frame which supports the mixer for processing and mixing mixable components at selected vertical heights. The frame is supported by three or four adjustable supports with either two or four of the adjustable supports arranged in a substantially A-frame configuration. Adjustment of the supports in the A-frame configuration simultaneously effects, in a single action, both a vertical displacement and a horizontal displacement of the corresponding support base so as to automatically provide an increased mixer support width at an increased mixer height, and a decreased mixer support width at a decreased mixer height. By virtue of the ability to adjust simultaneously both the vertical and horizontal displacement with a single action, the method of adjustably supporting the mixer is easier, faster, and safer.

### BACKGROUND OF THE INVENTION

1. Field of the Invention

The present invention relates generally to portable batch mortar mixers capable of processing a variety of mixable components, including mortar, cement, gravel, sand, dust and the like. More particularly, the present invention relates to mortar mixers which include a mechanism for adjusting the height and support width of the mixer support frame and are especially adapted for silo applications.

2. Description of the Prior Art

Devices are known for adjusting the height and support width of an apparatus such as a portable batch mixer. For example, U.S. Patent Application Publication No. US 2004/0240310 A1 of Lang discloses a slurry mixing apparatus with two-part adjustable legs that have a horizontal portion and a vertical portion (Lang FIG. 6). The horizontal portion adjusts the lateral distance that the support foot is from the mixer. The vertical portion adjusts the height of the mixer. US 2004/0240310 A1 of Lang also discloses a slurry mixing apparatus with outriggers moved by hydraulic rams that pivot hinged arms up and down (Lang FIG. 5).

The prior art does not disclose, however, an adjustable frame for a mortar mixer in which both the distance that the support foot is from the mixer, and the height that the mixer is from a support surface, are adjusted simultaneously so as to provide an increased mixer support width at an increased mixer height, and a decreased mixer support width at a decreased mixer height.

### SUMMARY OF THE INVENTION

An object of the present invention, therefore, is to provide an adjustable support frame for a mortar mixer which simultaneously adjusts the height and the support width, such that the mixer has an increased support width at an increased height, and a decreased support width at a decreased height.

In accordance with the present invention, an adjustably supported mixer includes a frame which supports the mixer for processing and mixing mixable components at selected vertical heights. The frame is, in turn, supported by three or four adjustable supports, with at least two of the adjustable supports arranged in a substantially A-frame configuration so as to automatically provide increased support width at an increased height, and a decreased support width at a decreased height. Each adjustable support includes a support sleeve rigidly affixed to the mixer frame, a support leg slidably received within the support sleeve, and a securing device to retain the support leg within the support sleeve in the selected adjusted position.

According to a first embodiment of the present invention, the adjustably supported mixer includes a frame which is supported by three legs. The support legs are preferably constructed of square metal tubing and each has a support leg base or plate welded to its lower end. One support leg, at the mixing drum end of the frame, is slidably received in a vertically oriented support sleeve (also preferably square) which is rigidly secured to the frame as by welding or the like. The support leg base or plate is perpendicular to the support leg, and this single support leg slides vertically within the support sleeve when adjusting the height of the frame.

The other two support legs are located at the other end of the frame, the heavier engine end, and are positioned in an A-frame configuration. The support leg bases are at opposed angles to their respective support legs, and the support legs slide within oppositely angled support sleeves rigidly secured to the frame. As such, the A-frame configured legs are capable of effecting, in a single action, both a vertical displacement and a horizontal displacement of the spaced support leg bases so as to automatically provide an increased mixer support base width at an increased mixer height, and a decreased mixer support width at a decreased mixer height. Thus, the adjustably supported A-frame configuration automatically provides increased mixer stability at increased mixer heights.

In a second embodiment of the present invention, the adjustably supported mixer includes a frame typically for use with heavier and larger mixers, and both ends of the mixer frame are supported by a pair of legs in an A-frame configuration. As such, the frame is capable of effecting, in a single action, at both ends a vertical displacement and a horizontal displacement of the support leg bases so as to automatically provide an increased mixer support base width at an increased mixer height, and a decreased mixer support width at a decreased mixer height. Thus, both ends of the mixer are automatically provided with increased mixer stability at increased mixer heights.

In order to retain each support leg in its selected position, the securing device takes the following preferred form. The support legs include a coordinated series of hole or aperture pairs along opposite sides of their lengths, preferably each pair spaced from the next pair at an equal distance. Each support sleeve has a corresponding opposite single pair of holes or apertures. When the support leg is slid within the support sleeve to the desired adjusted position, and the support sleeve holes align with a selected pair of support leg holes, a pin is inserted through the aligned holes and a clevis pin is inserted onto its protruding back end to secure the pin in place.

In the embodiment with A-frame configured support legs on both ends, the hole pattern on each leg is preferably the same. However, in the embodiment with a single vertical support leg on one side, the hole spacing on the vertical support leg is necessarily smaller to take into account that it is adjusting vertically while the A-frame configured support legs are adjusting at an angle.

Another object of the present invention is to provide a method of adjustably supporting the mixer which includes the following steps. Initially, the mixer is supported by the adjustable supports in a first position. The mixer is then engaged by a forklift or similar lifting vehicle. The mortar mixer of the present invention includes spaced generally horizontal tubular support beams as part of the frame, preferably two pairs running perpendicularly, front to back and end to end, for receiving the forks of a fork lift. Once the forks of the forklift are engaged in the tubular support beams and raised, the securing mechanisms are disengaged and the support legs adjusted to their desired positions. Adjusting the A-frame configured legs causes, in a single action, both a vertical displacement and a horizontal displacement of the corresponding support leg bases so as to automatically provide an increased mixer support width at an increased mixer height, and a decreased mixer support width at a decreased mixer height. Finally, after the securing mechanisms are reinstalled, the forklift lowers the mortar mixer into its desired operating position.

By adjusting the position of the A-frame configured supports, both the height of the mixer frame, i.e., the distance between the frame and a support surface, and the support width of the mixer frame, i.e., the distance between the opposed adjustable support leg bases or plates, are simultaneously adjusted. Thus, as the adjustable support legs are extended, both the height and the support width of the mixer are increased in one action. As the adjustable support legs are retracted, both the height and the support width of the mixer are decreased, again simultaneously.

By virtue of the ability to adjust both the vertical and horizontal displacement with a single action, the method of adjustably supporting the mixer is easier, faster, and safer than adjustment with conventional frame adjustment mechanisms.

These together with other objects and advantages which will become subsequently apparent reside in the details of construction and operation as more fully hereinafter described and claimed, reference being had to the accompanying drawings forming a part hereof, wherein like reference numbers refer to like parts throughout. The accompanying drawings are intended to illustrate the invention, but are not necessarily to scale.

### BRIEF DESCRIPTION OF THE DRAWINGS

FIG. 1 is a perspective view of an adjustably supported mixer according to the present invention (second embodiment), and is shown in use with a silo charge system.

FIG. 2 is a perspective view of an adjustably supported mixer according to a first embodiment of the present invention in a charge position as viewed from an engine end of the mixer, with mixer support legs retracted.

FIG. 3 is a perspective view of the mixer shown in FIG. 2, with the support legs extended.

FIG. 4 is a perspective view of the mixer shown in FIG. 2 as viewed from the drum end of the mixer, with the support legs retracted.

FIG. 5 is a perspective view of the mixer shown in FIG. 2 as viewed from the drum end of the mixer, with the support legs extended.

FIG. 6 is a drum-end view of the mixer shown in FIG. 5.

FIG. 7 is a drum-end view of the mixer according to the second embodiment of the present invention in the discharge position, with the supports legs extended.

FIG. 8 is the same view as FIG. 6, but with the support legs retracted.

FIG. 9 is the same view as FIG. 8, but with the mixing drum in a discharge position.

FIG. 10 is a partial cross-sectional end view of the mixer, as shown in FIG. 7.

FIG. 11 is a perspective view of the mixer shown in FIG. 1 in a discharge position as viewed from the engine end of the mixer, with the support legs extended.

FIG. 12 is a perspective view of the mixer shown in FIG. 1 in a charge position as viewed from the engine end of the mixer, with the support legs retracted.

FIG. 13 is a perspective view of the mixer shown in FIG. 1 as viewed from the hopper end of the mixer, with the support legs retracted.

FIG. 14 is a perspective view similar to FIG. 13 with the support legs extended.

FIG. 15 is a drum-end view of the mixer shown in FIG. 1 in the discharge position, with the support legs extended.

FIG. 16 is a drum-end partial cross-sectional view of the mixer shown in FIG. 1, with the supports retracted.

### DETAILED DESCRIPTION OF THE PREFERRED EMBODIMENTS

Although only preferred embodiments of the invention are explained in detail, it is to be understood that the invention is not limited in its scope to the details of construction and arrangement of components set forth in the following description or illustrated in the drawings. The invention is capable of other embodiments and of being practiced or carried out in various ways.

Also, in describing the preferred embodiments, terminology will be resorted to for the sake of clarity. It is intended that each term contemplates its broadest meaning as understood by those skilled in the art, and includes all technical equivalents which operate in a similar manner to accomplish a similar purpose.

The phrase “processing mixable components” as employed herein includes the typical functions of a batch mortar mixer, such as receiving (i.e., “charging”) the mixable components, mixing the mixable components, and discharging the mixture of components. The mixable components can be, for example, components for providing a mixture of plaster, mortar, grout, fireproofing, or other custom-designed mixes.

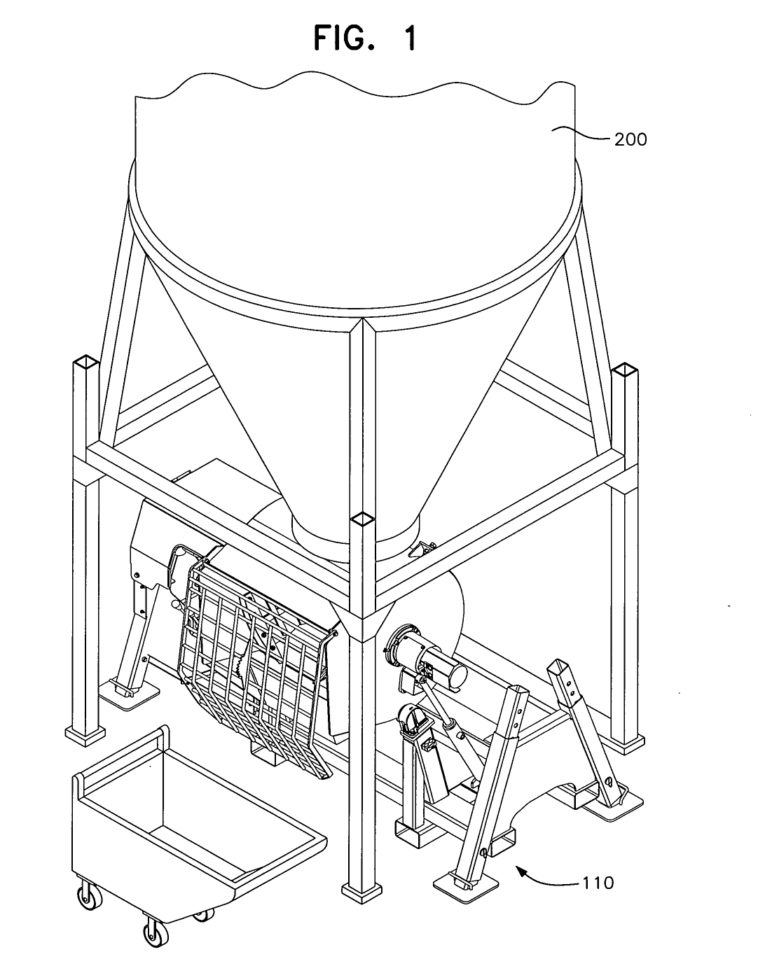

Referring to the drawings, FIG. 1 is a perspective view of an adjustably supported mixer 110 according to the present invention, having four adjustable supports. The mixer 110 is shown in use with a silo charge system 200. Mixer 110 is described in detail below, following the description of a mixer 10, which has three adjustable supports.

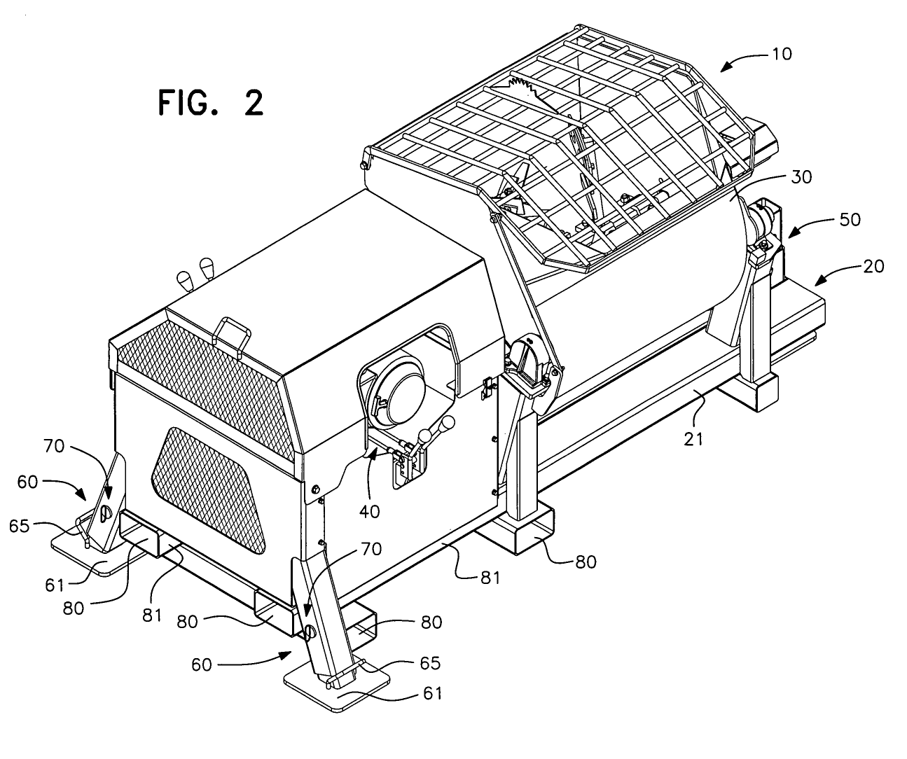

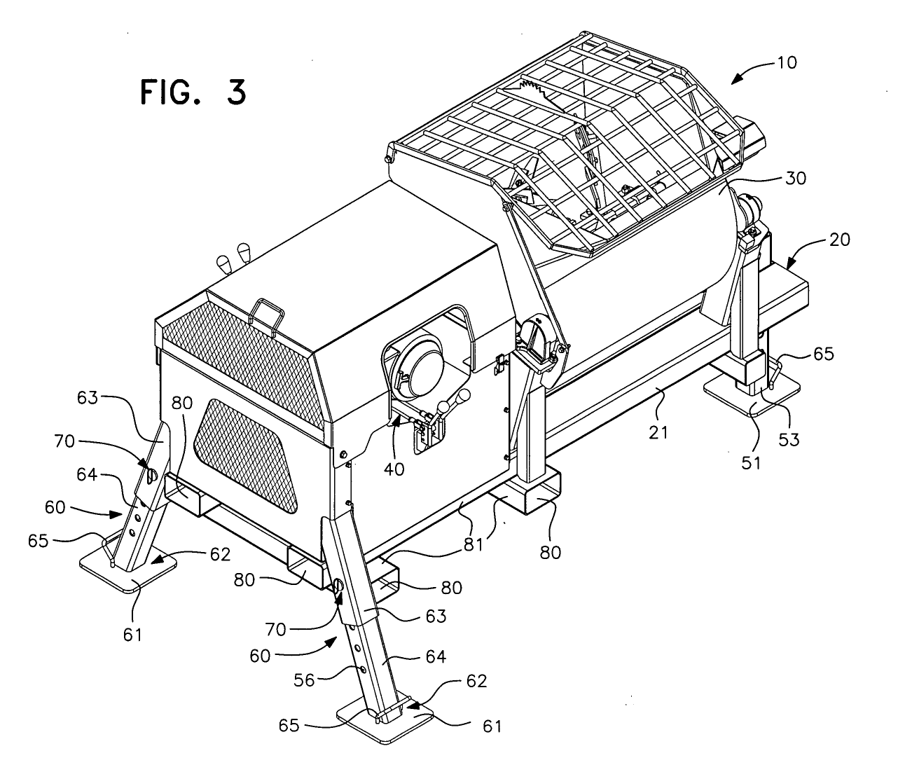

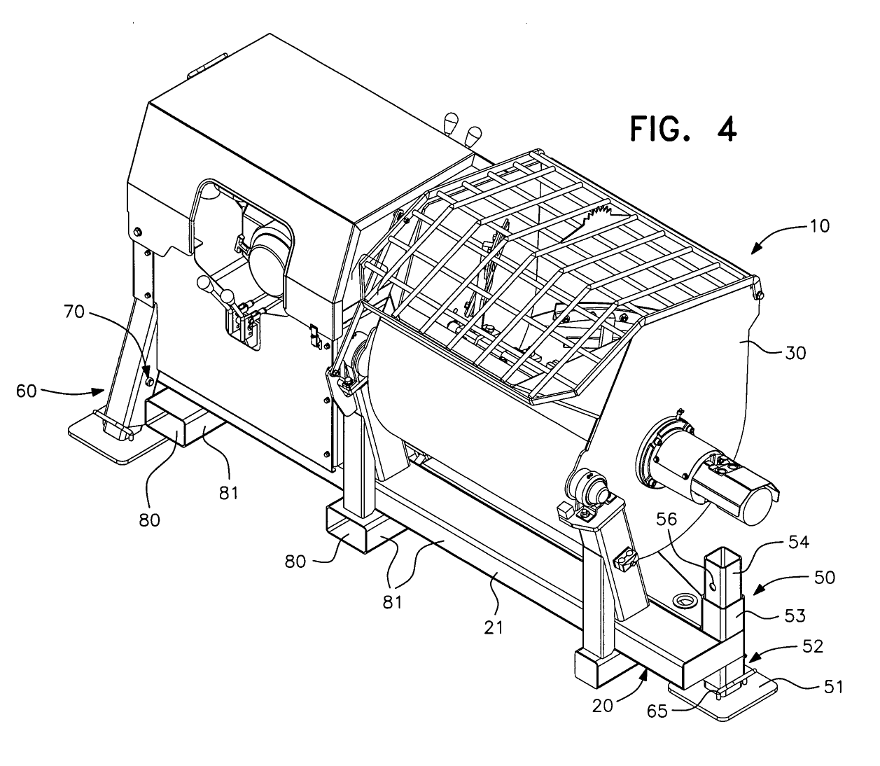

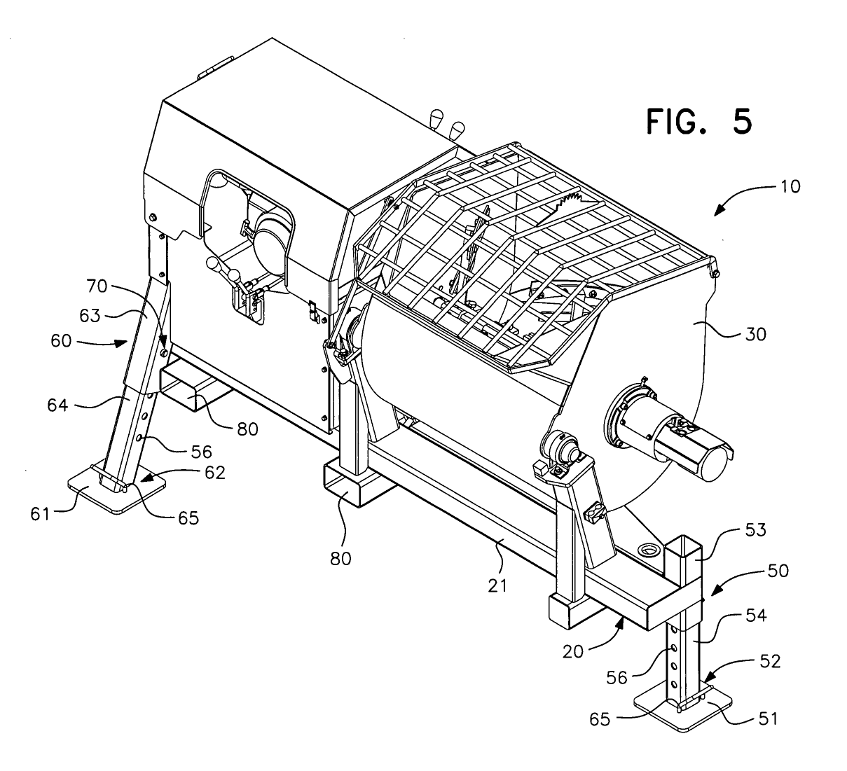

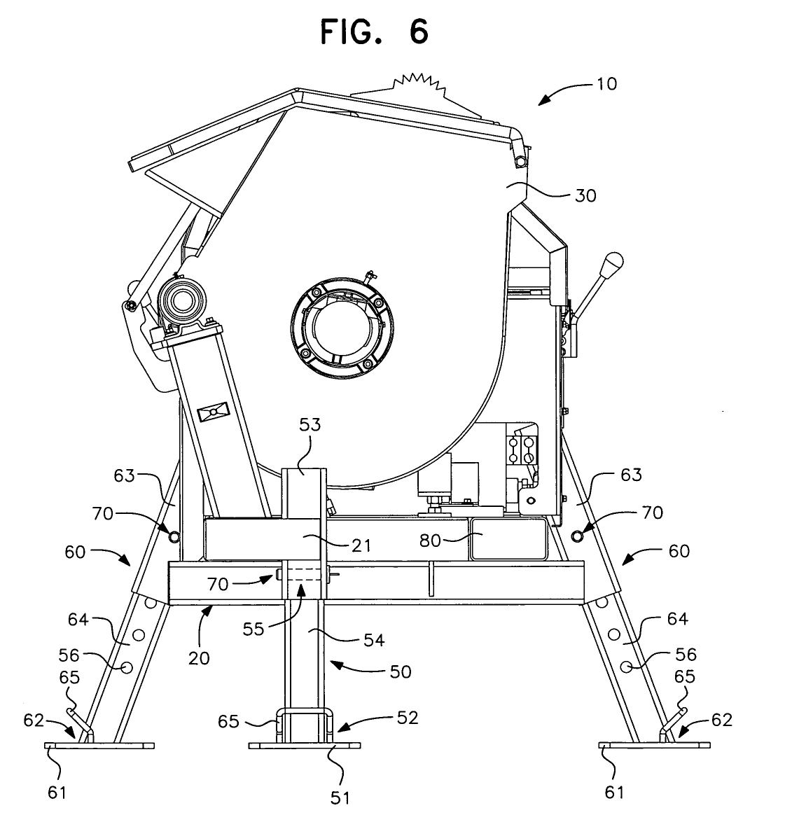

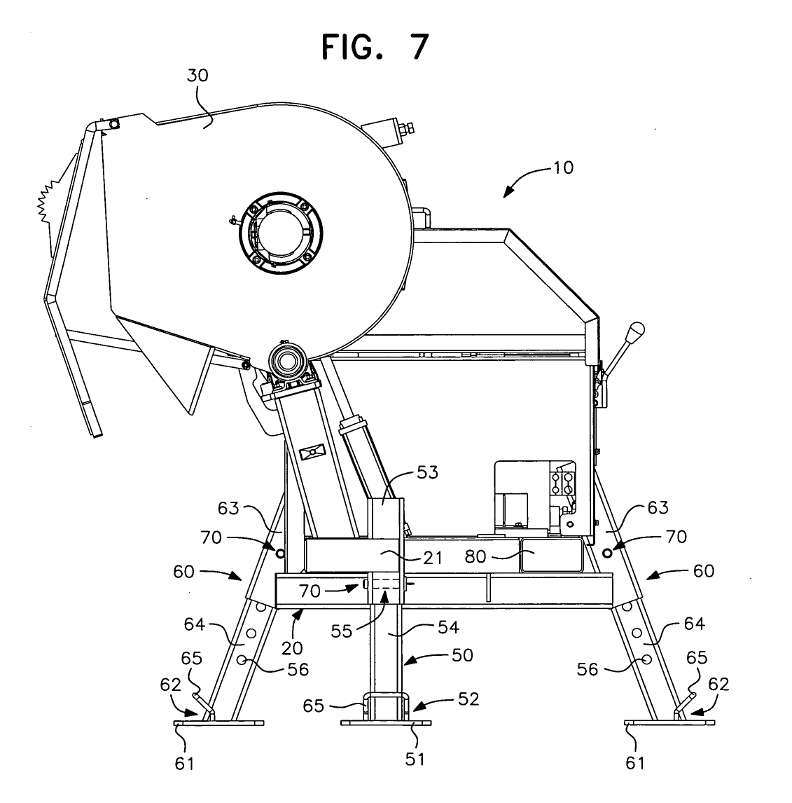

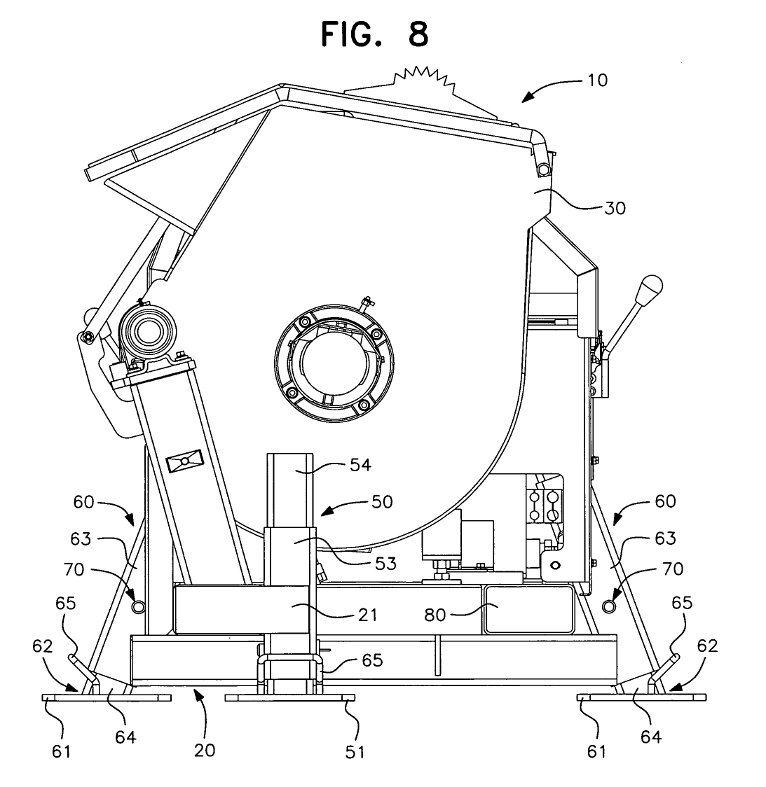

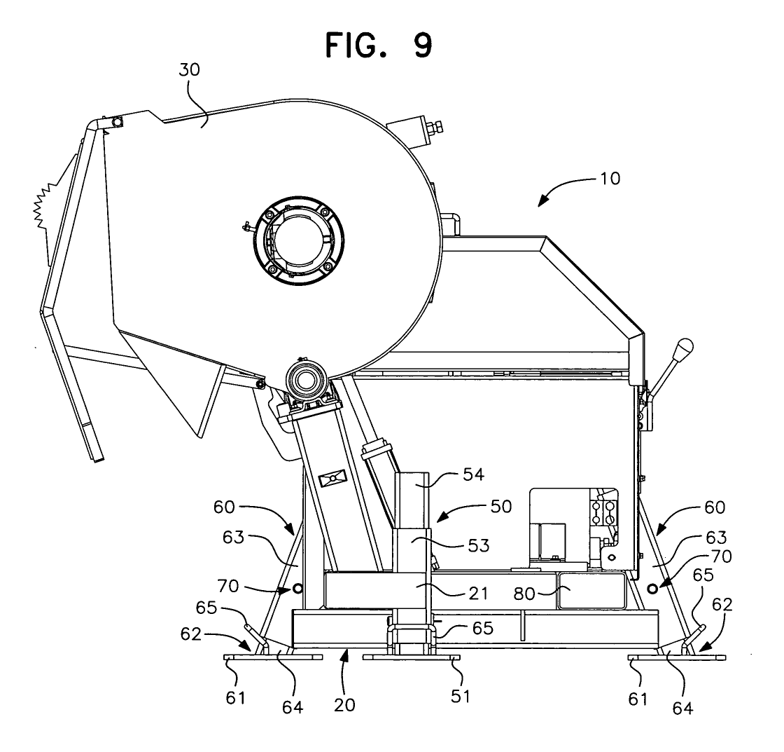

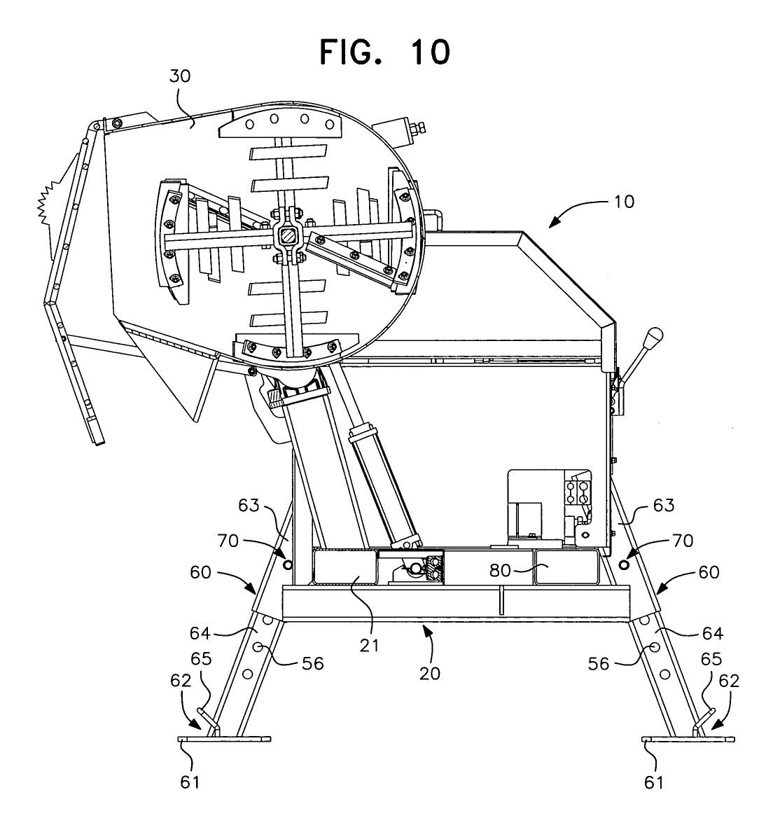

FIG. 2 is a perspective view of an adjustably supported mixer 10 according to the present invention, having three adjustable supports. FIGS. 2-10 illustrate mixer 10 from various perspectives.

As depicted in FIG. 2, the mixer 10 includes a frame, generally designated by reference numeral 20, supporting a mixing drum 30 for processing mixable components, and an engine 40 for driving the mixing process. The mixer 10 also includes a vertical adjustable support, generally designated by reference numeral 50, for supporting the drum end of the frame 20. The support 50 includes a support leg 54 which has a support leg base or support leg plate 51 at its lower end 52.

The adjustable support 50 includes a support sleeve 53, which together with the support leg 54, are capable of effecting a vertical displacement of the support leg base 51.

In a preferred embodiment, the support sleeve 53 and the support leg 54 are generally of a tubular configuration having a substantially square cross-section. The support leg 54 has a slightly smaller cross-sectional area than the cross-sectional area of the support sleeve 53 so that the support leg 54 is capable of slidable movement inside the support sleeve 53.

The mixer 10 also includes a second and a third adjustable supports 60 for supporting the frame 20. The opposed second and third adjustable supports 60 are in a substantially A-frame configuration. Each of the second and third supports 60 includes a corresponding support leg base 61 at leg end 62. Each of the second and third supports 60 is capable of effecting, in a single action, both a vertical displacement and a horizontal displacement of the corresponding support leg base 61 so as to provide an increased mixer support width at an increased mixer height, and a decreased mixer support width at a decreased mixer height. That is, for example, as each adjustable support leg base 61 is extended laterally outward from the mixer 10 so as to increase the height of the mixer 10, the support width of the mixer 10 is correspondingly increased.

The second and third adjustable supports 60 each include a support sleeve 63 and a support leg 64. The leg 64 terminates at its bottom end, i.e., support surface contacting end 62 in the support leg base 61. In a preferred embodiment, the sleeve 63 and the leg 64 are generally of a tubular configuration having a substantially square cross-section. The leg 64 has a smaller cross-sectional area than the cross-sectional area of the sleeve 63, and the leg 64 is capable of slidable movement inside the sleeve 63.

The frame 20 includes a plurality of bi-directional, generally horizontal, tubular support beams 81 having open ends 80 which are capable of receiving the forks of a forklift. Preferably two pairs of the beams 81 run perpendicularly, front to back and end to end. The beams 81 enable the frame 20 to be temporarily lifted when the adjustable supports 50, 60 are to be adjusted. The beams 81 also enable the mixer 10 to be positioned and transported.

Each of the adjustable supports 50, 60 includes components for facilitating the adjustment of the adjustable support by securing the sleeve 53 and the leg 54, and the sleeve 63 and the leg 64, in a desired configuration. In a preferred configuration, the sleeve 53 and the sleeve 63 each have a pair of corresponding sleeve apertures 55 on opposite sides of the sleeve, and the leg 54 and the leg 64 each have a plurality of leg apertures pairs 56 spaced along the length of the legs 54, 64. Each of the adjustable supports 50, 60 also includes a handle 65 near the respective support bases 51, 61 for manipulating the legs 54, 64.

In any adjusted support position, the sleeve apertures 55 are in alignment with one pair of leg apertures 56. A removable securing device 70 is housed within the aligned apertures 55, 56 so as to fix the adjustable support 50, 60 in its selected position. According to a preferred embodiment, the securing device 70 includes a clevis pin/cotter key set. The securing device 70 can, however, be any type, such as, for example a threaded fastener set, i.e., a bolt and a nut, that facilitates easy adjustment yet provides the necessary degree of secured alignment of the sleeve aperture 55 and the selected leg aperture 56.

To provide a different desired adjustable support position, a forklift engages the frame by inserting its forks into a desired pair of openings 80 at the end of beams 80. Once the mixer 10 is lifted, the supports 50, 60 can be adjusted. The handle 65 is grasped to maintain the position of the leg 54, 64, and the securing device 70 is temporarily removed. This enables the legs 54, 64 to be moved within their sleeve 53, 63 by manually sliding the leg 54, 64 either in or out. At the desired position, one of the leg aperture pairs 56 is aligned with the sleeve aperture pair 55. The removable securing device 70 is then rehoused within the aligned apertures 55, 56 so as to fix the adjustable support in the desired position. The above-described steps can be repeated for each of the adjustable supports 50, 60 until all of the adjustable supports are at their selected positions. The forklift then places the mixer down in the desired location.

By virtue of adjusting the position of the adjustable supports 60, both the height of the mixer frame 20, i.e., the distance between the frame 20 and the support surface, and the support width of the mixer frame 20, i.e., the distance between the opposed support bases 61, are simultaneously adjusted. That is, as the leg 64 is extended from the sleeve 63 to increase the height of the mixer 10 the support width of the mixer 10 is also automatically increased. As the leg 64 is retracted into the sleeve 63 to decrease the height of the mixer 10, the support width of the mixer 10 is automatically decreased.

According to one preferred embodiment, the mixer 10 has, in a leg 64 retracted configuration, a support width of about 51.5 inches and a height of about 50 inches. Correspondingly, in a leg 64 extended configuration, the mixer 10 has a support width of about 60 inches and a height of about 62 inches. Thus, by adjusting the legs 64 from a fully retracted position to a fully extended position, the mixer support width increases by about 8.5 inches for the pair of opposed adjustable supports 60 (i.e., by about 4.25 inches for each of the second and third adjustable supports 60) and the height increases by about 12 inches.

The A-frame configuration provides both vertical and horizontal stability, and precludes the necessity of a frame having both a vertical and a horizontal leg as in prior art designs. The A-frame configuration provides a wider support base, and thus greater stability, for the higher vertical positions of the mixer 10. The adjustability feature is particularly applicable to silo charge applications, where the height of the mixer 10 typically must be adjusted so that the container 30 can be sufficiently close underneath the silo 200.

The adjustable supports 50, 60 also offer variable height adjustment for the purpose of leveling the mixer 10. Depending upon the specific mixer service application and other factors such as the terrain at the job site, any desired number of the adjustable supports 50, 60 can be adjusted, and the adjustable supports can be adjusted by the same amount or by different amounts. Furthermore, by virtue of the capability to temporarily support the mixer 10, only one person is required to adjust the adjustable supports 50, 60.

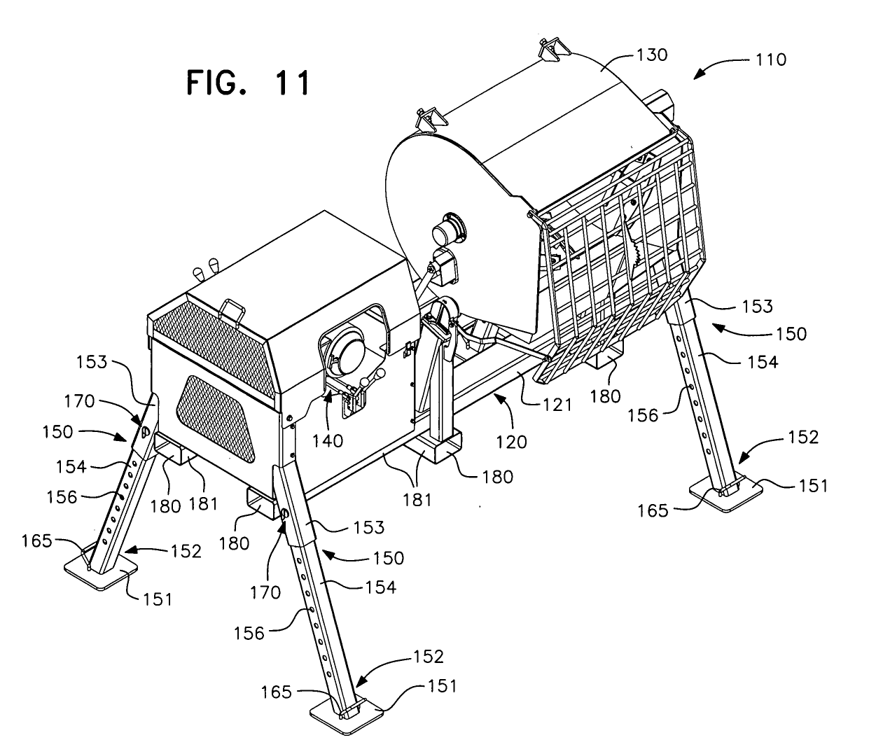

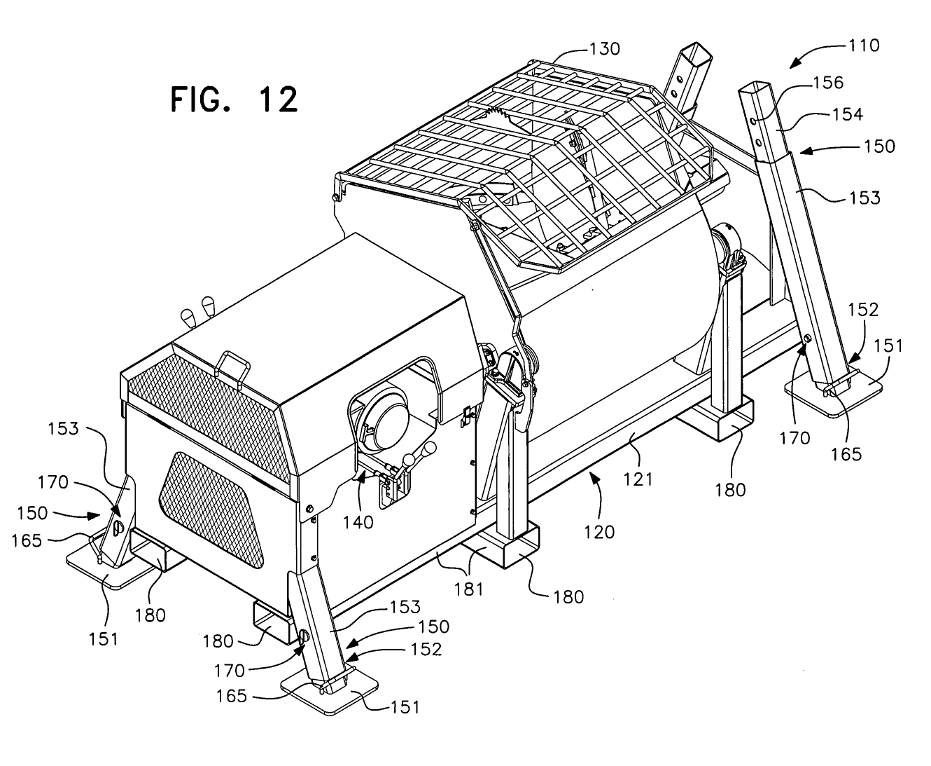

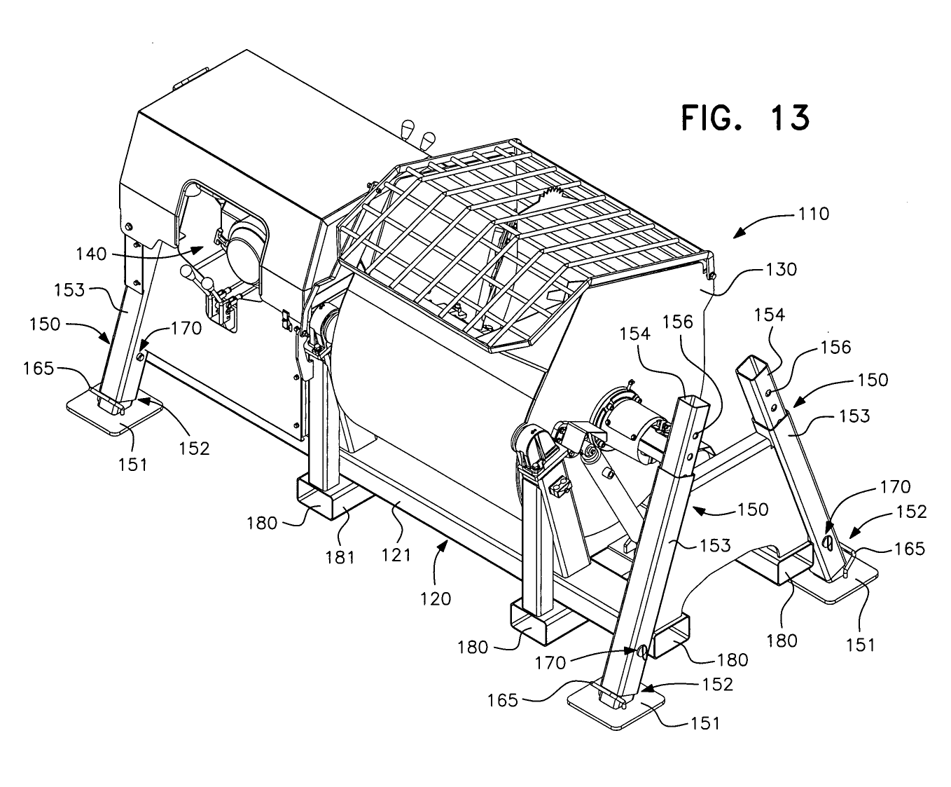

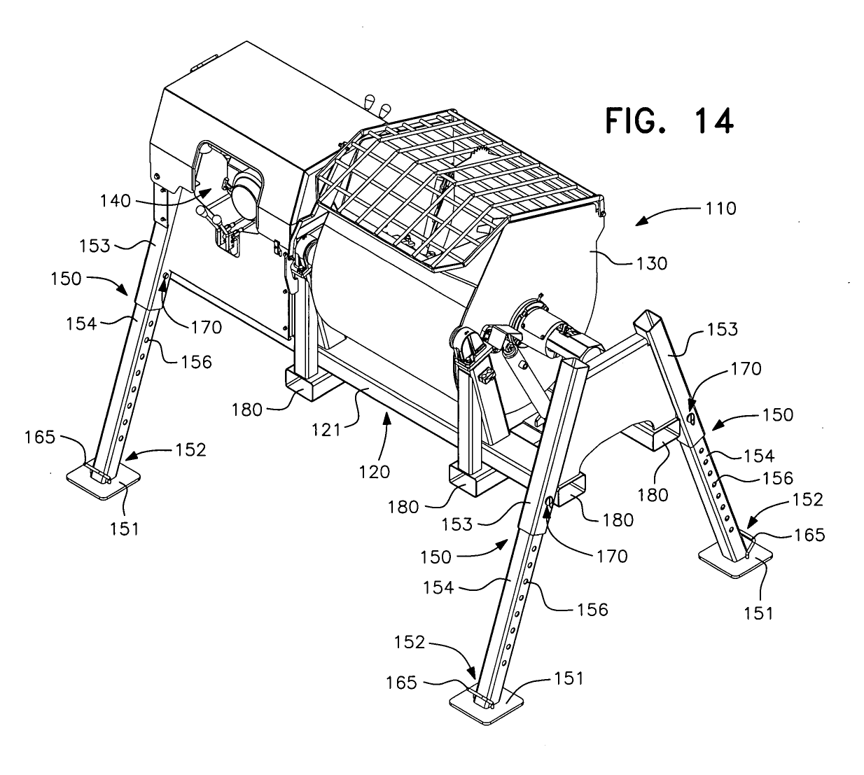

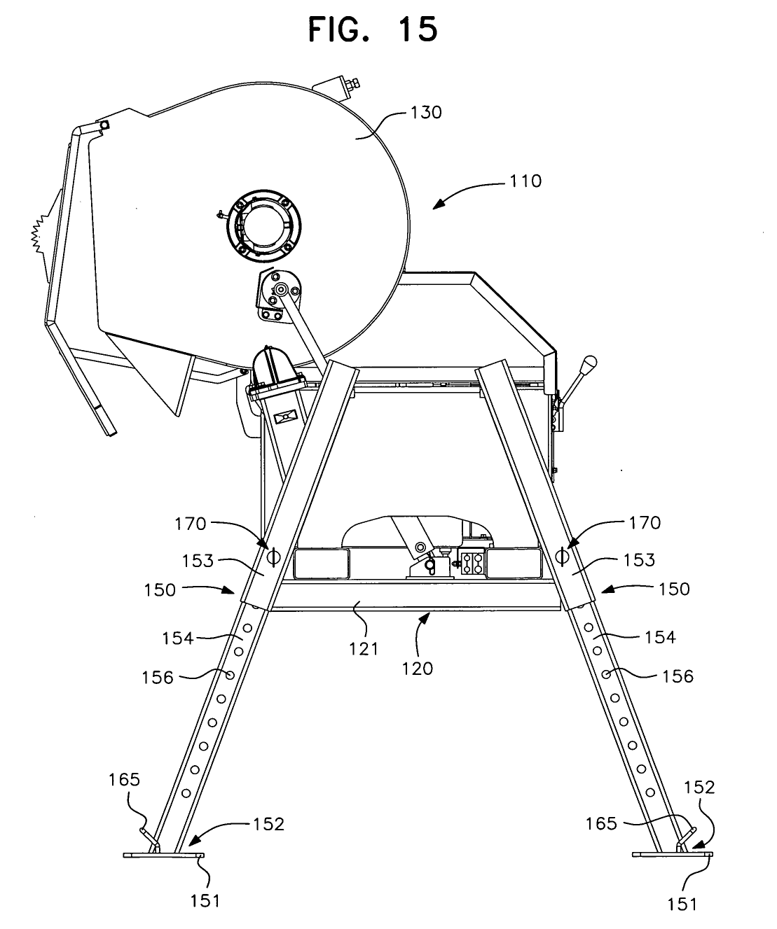

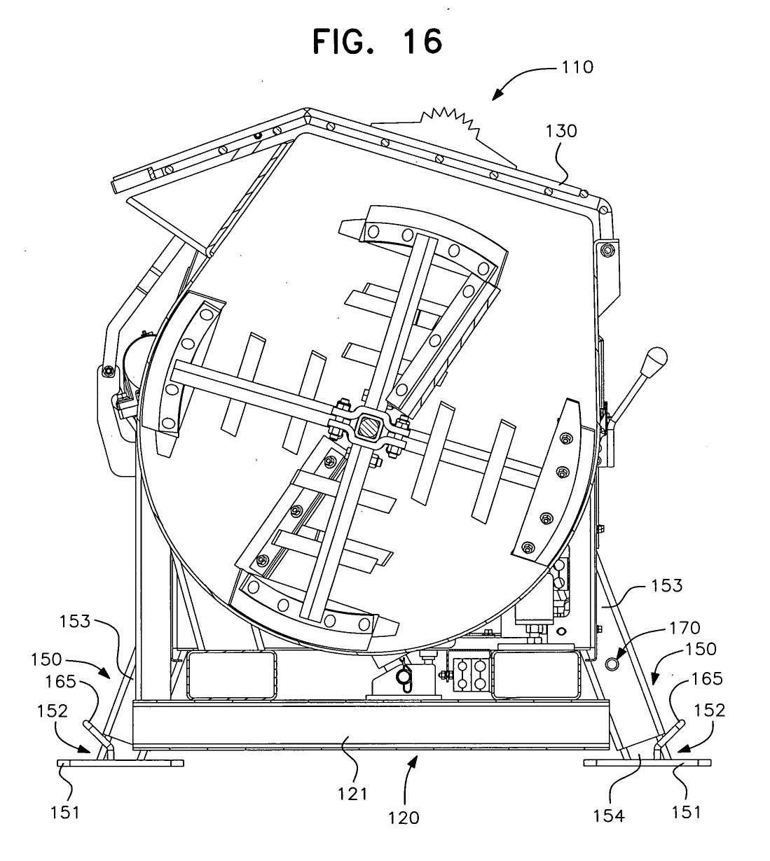

Turning now to the adjustably supported mixer 110 shown in FIGS. 11-16, inclusive, and also depicted in FIG. 1, mixer 110 is typically for use in heavier duty service. FIGS. 11-16 illustrate the mixer 110 from various perspectives. As depicted in FIG. 11, the mixer 110 includes generally a frame 120 supporting a container 130 for processing mixable components, an engine 140, and a plurality of adjustable supports 150 for supporting the frame 120.

In a preferred configuration, the mixer 110 has a first and a second pair of opposed adjustable supports 150 for supporting the frame 120. Each of the pairs of adjustable supports 150 is in a substantially A-frame configuration. Each support 150 includes a support base 151 at a support end 152. Each support 150 is capable of simultaneously effecting, in a single action, both a vertical displacement and a horizontal displacement of the support base 151 so as to automatically provide an increased mixer support width at an increased mixer height, and a decreased mixer support width at a decreased mixer height. That is, for example, as each adjustable support base 151 is extended outwardly so as to increase the height of the mixer 110, the support width of the mixer 110 is correspondingly increased.

The adjustable supports 150 each include a support sleeve 153 and a support leg 154. The leg 154 terminates at its bottom end, i.e., support surface contacting end 152, in the support base 151. In a preferred embodiment, the sleeve 153 and the leg 154 are generally of a tubular configuration having a substantially square cross section. The leg 154 has a smaller cross-sectional area than the cross-sectional area of the sleeve 153, and the leg 154 is capable of slidable engagement inside the sleeve 153.

The frame 120 includes a plurality of bi-directional, generally horizontal, tubular support beams 181 having open ends 180 capable of receiving the forks of a forklift. Preferably two pairs of the beams 181 run perpendicularly, front to back and end to end. The beams 181 enable the frame 120 to be temporarily supported when the adjustable supports 150 are adjusted. The beams 180 also enable the mixer 110 to be positioned and transported.

Each of the adjustable supports 150 includes components for facilitating the adjustment of the adjustable support by securing the sleeve 153 and the leg 154 in a desired configuration. In a preferred configuration, the sleeve 153 has aligned sleeve apertures 155 on opposite sides and the leg 154 has a plurality of leg aperture pairs 156 spaced on opposite sides along the length of the leg 154. Each of the adjustable supports 150 also includes a handle 165 near the respective support bases 151 for manipulating the leg 154.

In any adjusted support position, the sleeve apertures 155 are in alignment with one pair of the leg apertures 156. A removable securing device 170 is housed within the aligned apertures 155, 156 so as to fix the adjustable support 150 in its selected position. According to a preferred embodiment, the securing device 170 includes a threaded fastener set, i.e., a bolt and a nut. The securing device 170, can, however, be any type of device, such as, for example a clevis pin/cotter key set, that facilitates easy adjustment yet provides the necessary degree of secured alignment of the sleeve apertures 155 and the leg apertures 156.

To provide a different desired adjustable support position, the adjustment method is similar to that described for mixer 10. The forks of a forklift are inserted into any convenient pair of openings 181 at the open ends of tubular beams 120, and the mixer 110 is lifted. The handle 165 can then be grasped to maintain the position of the leg 154 while the securing device 170 is temporarily removed. This enables the leg 154 to be moved within the sleeve 153 by manually sliding the leg 154 either in or out. At the desired position, one pair of the leg apertures 156 is aligned with the pair of sleeve apertures 155. The removable securing device 170 is then rehoused within the aligned apertures 155, 156 so as to fix the adjustable support 150 in the desired position. The above-described steps can be repeated for each of the other adjustable supports 150 until all of the adjustable supports are at their selected positions. The forklift then places the mixer 110 in its desired location.

By virtue of adjusting the position of the adjustable supports 150, both the height of the mixer frame, i.e., the distance between the frame 120 and the support surface, and the support width of the mixer frame, i.e., the distance between the opposed support bases 151, are correspondingly adjusted. That is, as the leg 154 is extended from the sleeve 153, to increase the height of the mixer 10, the support width of the mixer 10 is also automatically increased. As the leg 154 is retracted into the sleeve 153 to decrease the height of the mixer 10, the support width of the mixer 10 is automatically decreased.

According to one preferred embodiment, the mixer 110 has, in a leg retracted configuration, a support width of about 51.5 inches and a height of about 52.5 inches. Correspondingly, in a leg extended configuration, mixer 110 has a support width of about 74 inches and a height of about 82.5 inches. Thus, by adjusting the legs 154 from a fully retracted position to a fully extended position, the mixer 110 support width increases by about 22.5 inches for each pair of opposed A-frame adjustable supports 150 (i.e., by about 11.25 inches for each of the four adjustable supports 150) and the height increases by about 30 inches.

The adjustable supports 150 are independently adjustable. Depending upon the specific mixer service application and other factors such as the terrain at the job site, any desired number of the adjustable supports 150 can be adjusted, and the adjustable supports 150 can be adjusted by the same amount or by different amounts.

The various embodiments of the invention described herein each include numerous structural and operational advantages. By virtue of the ability to simultaneously adjust both the vertical and horizontal displacement, and thereby provide a wider support area and thus greater stability at increased height, the method of adjustably supporting the mixer is easier, faster, and safer than adjustment with conventional frame adjustment mechanisms.

The foregoing is considered as illustrative only of the principles of the invention. Further, since numerous modifications and changes may readily occur to those skilled in the art, it is not desired to limit the invention to the exact construction and operation described and shown.

For example, one embodiment of the frames 20, 120 has been described above as including a mixer container 30, 130 as the supported element. In another possible embodiment, however, the supported element could be, for example, another type of mixer device or other construction equipment, or other supported element that benefits from being supported by a frame 20, 120 with an easily adjusted height and support width as described above.

Furthermore, although depicted in FIG. 1 as being usable in silo applications, the mixer embodiments 10, 110 can be used for bulk-bagged materials or where the height of the mixer varies for different mixing operations.

Similarly, in a preferred embodiment of the invention, the adjustable supports 50, 60, and 150 have been described herein as being manually adjusted. In another possible embodiment of the invention, however, the adjustable supports can be mechanically actuated, such as by a hydraulic system. Such a mechanically actuated embodiment, although adding to the total cost of the mixer, eliminates the need to temporarily support the frame 20, 120 while adjusting the position of the adjustable supports 50, 60, 150. Once adjusted, the supports can be locked off in their adjusted position by any suitable locking mechanism.

Accordingly, all suitable modifications and equivalents may be resorted to that fall within the scope of the invention as defined by the following claims.

What is claimed is:

1. An adjustably supported mortar mixer, comprising:
a frame supporting a mixer for processing mixable components; and
a plurality of adjustable supports for supporting the frame, each adjustable support having a lower end for engagement with a support surface;
at least two of said adjustable supports arranged in a substantially A-frame configuration to provide, in a single action, both a vertical displacement and a horizontal displacement of the corresponding support lower end so as to automatically provide increased mixer support width at increased mixer height and decreased mixer support width at decreased mixer height.

2. The mixer according to claim 1, wherein the plurality of adjustable supports is three and a third support provides a vertical displacement of its lower end.

3. The mixer according to claim 1, wherein the plurality of adjustable supports is four in two pairs and each pair is arranged in a substantially A-frame configuration.

4. The mixer according to claim 1, wherein each adjustable support includes a sleeve rigidly secured to the frame, an adjustable support leg slidably received inside the sleeve, and a securing element securing the support leg in the support sleeve at selected adjustable positions.

5. The mixer according to claim 4, wherein said sleeve and said support leg are both of a tubular configuration having a substantially square cross section.

6. The mixer according to claim 5, wherein said sleeve includes a pair of opposed sleeve apertures, said support leg includes a plurality of support leg aperture pairs spaced along a length of the support leg, and said securing device being capable of insertion within an aligned configuration of the sleeve apertures and a selected pair of support leg apertures so as to fix each adjustable support in a selected position.

7. The mixer according to claim 1, wherein said adjustable supports are independently adjustable so as to be capable of being adjusted with a same, or a different, amount of adjustment.

8. The mixer according to claim 1, wherein the frame includes lift receptacles for receiving a source of temporary support for the mixer.

9. The mixer according to claim 1, wherein said mixer is for silo applications.

10. An adjustably supported mortar mixer, comprising:
a frame supporting a mortar mixer for processing mixable components; and
at least two pairs of adjustable supports for supporting the frame, each pair being arranged in a substantially A-frame configuration at opposite sides of said frame and being capable of effecting in a simultaneous action, both a vertical displacement and a horizontal displacement of the adjustable supports so as to automatically provide increased mixer support width at increased mixer height and decreased mixer support width at decreased mixer height.

11. The mixer according to claim 10, wherein said frame includes generally horizontal tubular supports spaced and sized to receive forks of a fork lift or similar truck to lift said mixer for adjusting said adjustable supports.

12. The mixer according to claim 10, wherein each adjustable support includes a sleeve rigidly secured to the frame, an adjustable support leg slidably received inside the sleeve, and a securing element securing the support leg in the support sleeve at selected adjustable positions.

13. The mixer according to claim 12, wherein said sleeve and said support leg are both of a tubular configuration having a substantially square cross-section.

14. The mixer according to claim 13, wherein said sleeve includes a pair of opposed sleeve apertures, said support leg includes a plurality of support leg aperture pairs spaced along a length of the support leg, and said securing device being capable of insertion within an aligned configuration of the sleeve apertures and a selected pair of support leg apertures so as to fix each adjustable support in a selected position.

15. A method of simultaneously adjusting the height and support width of a mortar mixer having a frame and a plurality of adjustable supports, each adjustable support having a support base at its lower end for engagement with a support surface, said method comprising the steps of:
temporarily lifting said mixer by said frame above said support surface;
adjusting at least one of said adjustable supports to simultaneously effect, in a single action, both a vertical displacement and a horizontal displacement of its corresponding support base so as to automatically provide an increased mixer support width at an increased mixer height or a decreased mixer support width at a decreased mixer height; and
lowering said mixer to place the support bases in contact with the support surface with an increased mixer height and support width or a decreased mixer height and support width.

16. The method according to claim 15, wherein the adjustable supports further include a sleeve with a sleeve aperture, a support leg with a plurality of support leg apertures spaced along a length of the support leg, a removable securing device capable of being housed within the sleeve aperture and the support leg apertures so as to fix the adjustable support, and a handle for manipulating the support leg, and wherein the step of adjusting includes the steps of supporting the handle to maintain the support leg in the first position;
temporarily removing the securing device;
moving the support leg within the sleeve and, at the second position, aligning one of the support leg apertures with the sleeve aperture; and
rehousing the temporarily removed securing device in the aligned support leg aperture and sleeve aperture so as to fix the adjustable support in the second position.

17. The method according to claim 15, further comprising repeating the step of adjusting for each of the adjustable supports.

18. The method according to claim 15, wherein the frame includes lift receptacles, and the step of temporarily lifting the mixer includes inserting forklift forks in the lift receptacles.

19. The method according to claim 15, wherein the adjusting step includes adjusting a least two of said adjustable supports arranged in an A-frame configuration.
